(19) United States
(12) Patent Application Publication
(10) Pub. No.: US 2005/0190050 A1
(43) Pub. Date: Sep. 1, 2005

(54) Rear light out indicator

(76) Inventor: Janine Y. Ross, Miami, FL (US)

Correspondence Address: Janine Y. Ross, Bldg 27, 7160 NW 179 Street, Apt 305, Miami, FL, 33015, US

(21) Appl. No.: 10/789,577

(22) Filed: Mar. 1, 2004

(51) Int. Cl. B60Q 11/00

(52) U.S. Cl. 340/458; 340/641

(57) ABSTRACT

The automobile industry would benefit great by the invention of the rear light out indicator. It is a sensor light that illuminates once a rear light is out on the automobile. This rear light out indicator will require the automobile industry to simply add a sensor that illuminates in the area of the dashboard as other sensors such as the ones that indicate a need to refuel or that indicates low battery power, that the automobile is overheating, low oil or a need to service the engine.

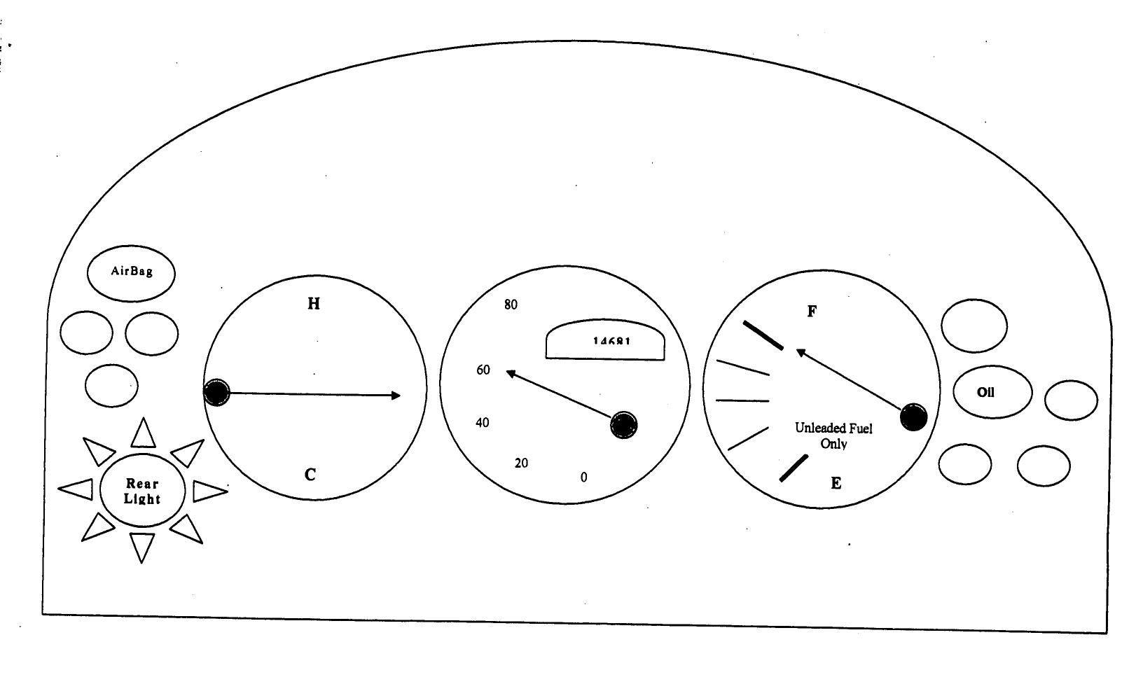

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

This field of endeavor to which this invention pertains is the automobile industry.

### BRIEF SUMMARY OF THE INVENTION

This invention would add a sensor light in the dashboard of automobiles that indicates to the driver that a rear light(s) is out.

### BRIEF DESCRIPTION OF THE SEVERAL VIEWS OF THE DRAWING

### DETAILED DESCRIPTION OF THE INVENTION

1. This invention would add a sensor light in the dashboard of automobiles that indicates to the driver that a rear light(s) is out. In the past and presently, one normally only finds out that one of the automobile's rear lights is out by being stopped by a law enforcement officer or if a passerby is kind enough to inform the driver. Being stopped by a law enforcement officer for having a rear light out can lead to being ticketed, which can be costly to the driver. Presently, there is no other way of knowing when a rear light is out on one's automobile.

2. The automobile manufacturer would simply have to add a sensor that illuminates in the area of the dashboard as other sensors such as the ones that indicate a need to refuel or that indicates low battery power, that the automobile is overheating, low oil or a need to service the engine. A new space for the indicator should not be needed as most automobiles have extra spaces that are not currently used that can be utilized as the space for the rear light out indicator. As with the brake light indicator that came out a few years ago, this new rear light out indicator can be manufactured in new models or a customer could have it added to an older model automobile. Customers can have the choice of whether or not they want it added as an extended package deal or it can be as a custom part of new automobiles.

1. What I claim as my invention is a rear light out indicator (sensor) which illuminates in the dashboard area of an automobile indicating to the driver that a rear light(s) is out.
